(19) United States
(12) Patent Application Publication
(10) Pub. No.: US 2002/0076358 A1
(43) Pub. Date: Jun. 20, 2002

(54) Device and method for the recombination of hydrogen and oxygen in a gas mixture

(76) Inventors: Bernd Eckardt, Bruchkobel (DE); Axel Hill, Stockstadt (DE)

Correspondence Address: LERNER AND GREENBERG, P.A, PATENT ATTORNEYS AND ATTORNEYS AT LAW, Post Office Box 2480, Hollywood, FL, 33022-2480, US

(21) Appl. No.: 09/821,858

(22) Filed: Mar. 30, 2001

Related U.S. Application Data
(63) Continuation of application No. PCT/DE99/03134, filed on Sep. 29, 1999.

(30) Foreign Application Priority Data
Sep. 30, 1998 (DE) 198 44 982.8

(51) Int. Cl. F28D 1/00; G05B 1/00

(52) U.S. Cl. 422/105; 423/580.1; 422/198; 422/108

(57) ABSTRACT

A device and a method for recombining hydrogen and oxygen in a gas mixture, especially for a nuclear plant, includes feeding the gas mixture to a heating chamber through a feed line in which a blower is connected. A control unit associated with the blower is provided to adjust the delivery rate of the blower in accordance with the hydrogen content of the gas mixture. This provides a particularly simple measure for reliably reducing the hydrogen present in the gas mixture, even in different operating states.

### CROSS-REFERENCE TO RELATED APPLICATION

This application is a continuation of copending International Application No. PCT/DE99/03134, filed Sep. 29, 1999, which designated the United States.

### BACKGROUND OF THE INVENTION

### Field of the Invention

The invention relates to a device for the recombination of hydrogen and oxygen in a gas mixture, in which the gas mixture can be fed into a heating chamber through a feed line in which a blower is connected. The invention also relates to a method for the recombination of hydrogen and oxygen in a gas mixture.

In the case of malfunction or accident situations in a nuclear power plant in which, for example, zirconium can be produced through overheating of the core, the possibility must be taken into account that hydrogen gas and carbon monoxide may be formed and set free within the safety vessel or containment surrounding the core of the reactor. As a result, explosive gas mixtures may be generated within the containment.

Various devices or methods are under discussion for preventing the formation of those kinds of explosive gas mixtures in the containment of a nuclear power plant. They include, for example, devices such as catalytic or thermal recombinators, catalytically or electrically driven ignition devices, or a combination of the two above-mentioned devices, as well as devices and methods for rendering the containment permanently or subsequently inert. Thermal recombinators in particular are characterized by wide-reaching resistance against the substances which may be released from the reactor core and are therefore also especially reliable under a wide variety of different operating conditions.

In a thermal recombinator which is known, for example, from German Patent DE 24 11 006 C2, corresponding to U.S. Pat. No. 3,907,981, related publication B 510,682, and U.S. Pat. No. 4,000,978, a heating chamber is usually provided to which the gas mixture can be fed through a feed line. Inside the heating chamber the gas mixture is heated to a high enough temperature that a recombination takes place between the hydrogen and the oxygen carried in the gas mixture, leading finally to the hydrogen level being reduced to below a predefined limit value or to below a limit of detection. Feeding of the gas mixture to the heating chamber is ensured through a blower connected in the feed line.

A device for controlling the heat output of the heating chamber is usually provided in order to enable the operating parameters of such a thermal recombinator to be set according to demand. Thus, in a thermal recombinator which is known from German Patent DE 33 39 242 C2, for example, guidance or control of the recombination reaction is performed through electrical control of heating elements provided for heating the heating chamber. During operation of the thermal recombinator known from German Patent DE 24 11 006 C2, corresponding to U.S. Pat. No. 3,907,981, related publication B 510,682, and U.S. Pat. No. 4,000,978, provision is also made for heating up the heating chamber and for subsequent heat output control dependent on the heat of reaction.

The structure of the heating chamber and the associated components in a concept of that kind must be dimensioned sufficiently accurately, with respect to the heat output to be provided and the volume rate of flow of the gas mixture to be processed. Especially in the case of a specified target volume rate of flow, which is possibly also combined with a demand for redundancy in the case of safety-relevant components, this can lead to a relatively large-dimensioned and therefore costly heating device for the heating chamber.

### SUMMARY OF THE INVENTION

It is accordingly an object of the invention to provide a device and a method for the recombination of hydrogen and oxygen in a gas mixture, in particular for the containment atmosphere of a nuclear power plant, which overcome the hereinafore-mentioned disadvantages of the heretofore-known devices and methods of this general type, in which a reliable reduction of the amount of hydrogen carried in the gas mixture is guaranteed by using especially simple measures, even under different operating conditions and in which the method is especially suited for operation of the device.

With the foregoing and other objects in view there is provided, in accordance with the invention, a device for the recombination of hydrogen and oxygen in a gas mixture, comprising a heating chamber, a feed line for feeding a gas mixture having a hydrogen content with a parameter characteristic, into the heating chamber, and a blower connected in the feed line and having a delivery rate. A control unit is associated with the blower for adjusting the delivery rate of the blower in dependence on the parameter characteristic for the hydrogen content of the gas mixture.

The parameter characterizing the hydrogen content can be a direct measured value of the hydrogen content. Alternatively the parameter can, for example, be a measured value of the temperature of the gas mixture flowing out of the heating chamber. That is because, if the values of other boundary parameters are known, knowing this temperature makes it possible to draw conclusions about the hydrogen content of the gas mixture.

The invention is based on the concept that a reliable reduction of the amount of hydrogen in the gas mixture can be achieved with especially simple measures. That is because, in terms of its operating parameters, the recombination device is adaptable in an especially simple way to a large number of operating situations. Moreover, the delivery rate of the blower and thereby the volume rate of flow of the gas mixture into the heating chamber is conceived not as a fixed but as a variable operating parameter. In order to provide an especially high efficiency of the recombination device, in particular also for comparatively low hydrogen concentrations in the gas mixture, the control unit for the blower is constructed in such a way that the input parameter for controlling the delivery rate takes into account the actual concentration of hydrogen in the gas mixture. Therefore, in accordance with another feature of the invention, there is provided a hydrogen sensor for determining the hydrogen content of the gas mixture. The control unit has an input side connected to the hydrogen sensor.

A default initial value is provided for the delivery rate upon start-up of the recombination device. Depending on the measured hydrogen concentration in the gas mixture, and taking the heat of reaction released through the recombination reaction into account as well, the flow rate through the heating chamber is continuously increased through corresponding adjustment of the delivery rate of the blower. In this way, provision can be made for increasing the delivery rate if necessary, for example at higher hydrogen concentrations, to a value double that of the start-up value, without the heating chamber as such having to be constructed specifically for the maximum flow rate. At the same time, the temperature of the heating chamber can also be regulated through the continuous control of the flow rate, at almost constant heat output.

In accordance with a further feature of the invention, the heating chamber is heatable by a number of heating elements, the heat output of which can advantageously be controlled or regulated in order to provide an especially high degree of flexibility in operating the recombination device.

Thus, in accordance with an added feature of the invention, every heating element is disposed inside its own flow pipe, so that for each of these an annular passage between the heat pipe and its respective flow pipe is provided as a flow region for the gas mixture.

In order to avoid overheating, the heating elements are advantageously divided in an axial direction into a number of power levels, preferably three altogether. The heating elements are advantageously connected electrically in a delta connection whereby preferably three series are provided, each of these with eight heating elements connected in series.

In accordance with an additional feature of the invention, there is provided a reaction chamber connected to the downstream side of the heating chamber. In this reaction chamber, the gas mixture reacted in the heating chamber is mixed with still unreacted gas mixture. The already reacted gas mixture is comparatively strongly heated, especially as a result of the exothermic character of the recombination reaction. As a result of the reacted gas mixture mixing with the still unreacted gas mixture, the latter is heated up causing the recombination reaction to be re-initiated. It is thus possible to achieve an especially extensive reduction in the amount of hydrogen originally present in the gas mixture. The reaction chamber can, in particular, be constructed as a toroidal chamber to which all of the flow pipes from the heating chamber are led together, so that especially homogeneous mixing of all of the partial gas streams led through the heating chamber occurs. In a configuration of this kind, even if one heating element fails completely, the additional recombination in the reaction chamber guarantees a reliable reduction in the amount of hydrogen.

In accordance with yet another feature of the invention, there is provided a static mixer connected downstream of the heating chamber. This static mixer preferably has a number of mixing elements which are constructed for the application of flowing medium with a flow rate greater than 10 m/s. The static mixer thereby effects an especially homogeneous mixing of the partial streams of the gas mixture led through the heating chamber. Therefore, especially in coordination with the reaction chamber, an effective transfer of heat takes place from reacted gas mixture to unreacted gas mixture and thereby the initiation of a recombination reaction is also guaranteed in the still unreacted hydrogen in the gas mixture.

In accordance with yet a further feature of the invention, which is advantageous with respect to the flow path for the gas mixture, the static mixer can be heated by at least a partial stream of the gas mixture that is heated as a result of the exothermic recombination reaction. A configuration of this kind enables especially effective utilization of the exothermic energy of reaction of the recombination reaction. Therefore, initiation of the recombination reaction of the still unreacted hydrogen in the gas mixture takes place together with the mixing together of the partial streams of gas mixture flowing from the heating chamber.

In accordance with yet an added feature of the invention, in order to limit the thermal stresses on load bearing or load stressed structural elements of the recombination device, the heating chamber is advantageously disposed inside an internally insulated housing. This can be provided through the use of a double-casing structure of the housing in such a way that there is an air gap between an outer casing and an inner casing. This can also be provided through the use of temperature and radiation resistant insulating material. The inner surface of the housing can also be metallized in order to reduce heat transmission through irradiation. The pressure stressed outer casing of the housing is also advantageously constructed to meet the highest safety standards and at the same time to be thermally decoupled from the heating chamber and the reaction chamber. The recombination device is thus constructed for an encapsulated recombination which only has low heat losses to the outside. The result of this construction is that the heat released by the exothermic recombination reaction can be used especially favorably for initiation of a further recombination reaction in the still unreacted gas mixture.

The resulting possibility of decoupling the heat stressed components from the mechanically stressed or pressure stressed components and the use of materials known to be suitable, enables these components to be constructed to require especially small quantities of material and to guarantee an especially long service life of, for example, more than 1000 operating hours. In particular, it is possible through a construction of this kind to ensure that, even while the recombination device is operating under full load, the mechanically stressed or pressure stressed components are not exposed to especially high temperatures, for example to no higher than 450° C. However, inside the recombinator device, especially high temperatures of approximately 800° C. can occur, since there are no pressure stresses. The high rates of reaction resulting from these high temperatures guarantee an effective reaction even at high flow rates. In the temperature range of up to 450° C. for the mechanically stressed components there are many materials which comply with current safety standards for nuclear plants, for example the ASME Code, and which include materials with a long serviceable life that can be used for construction of the pressure stressed components.

In accordance with yet an additional feature of the invention, there is provided a splash or spray cooler connected on the downstream side of the heating chamber in such a way that the housing of the splash cooler is connected directly with the housing provided for the heating chamber. The splash cooler thereby enables the gas mixture flowing out of the heating chamber or reaction chamber to be effectively cooled to a temperature level generally recognized as being safe for the outer casing of the other components disposed in the containment. This configuration of the splash cooler directly on the heating chamber, in particular with the formation of a monolithic housing block having a common “cold” outside shell, removes any necessity to use high-temperature-resistant material for the piping.

With the objects of the invention in view, there is also provided a method for the recombination of hydrogen and oxygen in a gas mixture, which comprises feeding the gas mixture through a feed line having a blower, into a heating chamber. A delivery rate of the blower is adjusted in dependence on a parameter characteristic for a hydrogen content of the gas mixture.

The advantages achieved with the invention reside in particular in the fact that through the demand-driven adjustment of the delivery rate of the blower which is dependent on the hydrogen content of the gas mixture and/or the reaction zone temperatures, the recombination device can be used in an especially flexible and variable manner. Thus, an especially high efficiency in reacting the hydrogen can be achieved at relatively low cost. It is particularly at a low hydrogen content that the delivery rate can be adjusted especially well to the available heat output. Moreover, because the pressure stressed components of the recombination device are thermally decoupled from the heating chamber and/or the reaction chamber, even with a comparatively thin-walled construction of the structural elements, an especially high reaction zone temperature is possible. Despite this, it is also possible to comply with stringent safety standards for the outer shell in an especially simple way.

Other features which are considered as characteristic for the invention are set forth in the appended claims.

Although the invention is illustrated and described herein as embodied in a device and a method for the recombination of hydrogen and oxygen in a gas mixture, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic diagram of a device for recombination of hydrogen and oxygen in a gas mixture;

FIG. 2 is an enlarged, diagrammatic, sectional view of a recombinator unit of the device according to FIG. 1;

FIG. 3 is a view similar to FIG. 2 of an alternative recombinator unit of the device according to FIG. 1; and

FIG. 4 is a further enlarged, fragmentary, sectional view of a reaction chamber of the recombinator unit according to FIG. 2 or FIG. 3.

### DESCRIPTION OF THE PREFERRED EMBODIMENTS

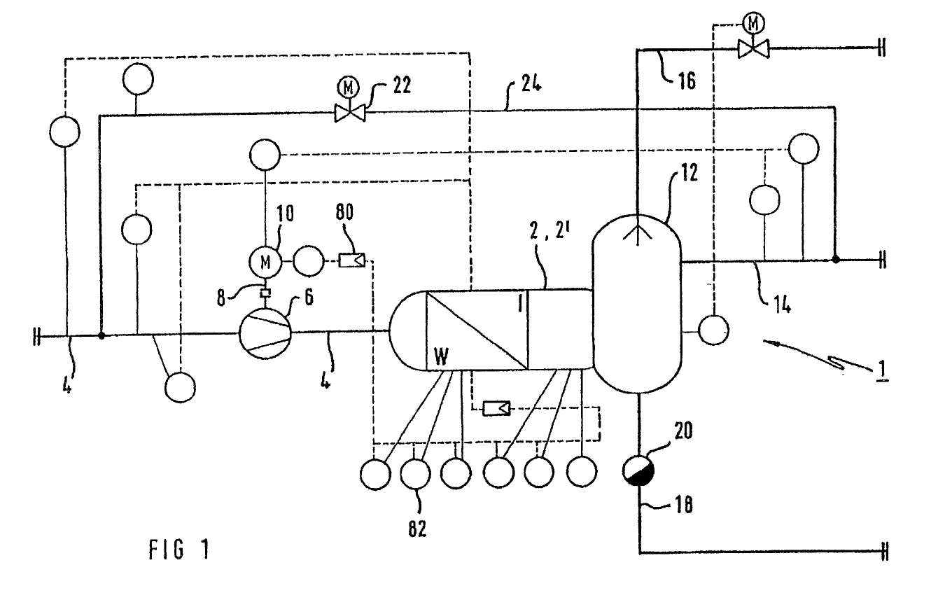

Referring now in detail to the figures of the drawings, in which equivalent parts carry the same reference numerals, and first, particularly, to FIG. 1 thereof, there is seen a device 1 which is intended for the recombination of hydrogen with oxygen in a gas mixture, namely in the containment atmosphere of a non-illustrated nuclear power plant in the event of a malfunction. For this purpose the device 1 includes a recombinator unit 2, 2′ to which the gas mixture can be led through a feed line 4. A conveyor blower 6 is connected in the feed line 4 in order to convey the gas mixture into the recombinator unit 2, 2′. A drive motor 10 is connected to the blower 6 by a shaft 8. The recombinator unit 2, 2′ is connected on the outlet side to a spray or splash cooler 12 which is in turn connected to an outlet line 14 for the gas mixture. The splash cooler is connected on the inlet side to a line 16 for feeding cooling water. Water which is neither used nor evaporated during cooling can be led out of the spray or splash cooler 12 through a water outlet line 18 in which a steam trap 20 is connected.

The feed line 4 is connected directly to the outlet line 14 through a bypass line 24 which can be shut off through the use of a valve 22. The feed line 4 bypasses the recombinator unit 2, 2′ and the spray or splash cooler 12 connected downstream thereof for the purpose of bypassing the device 1, if necessary.

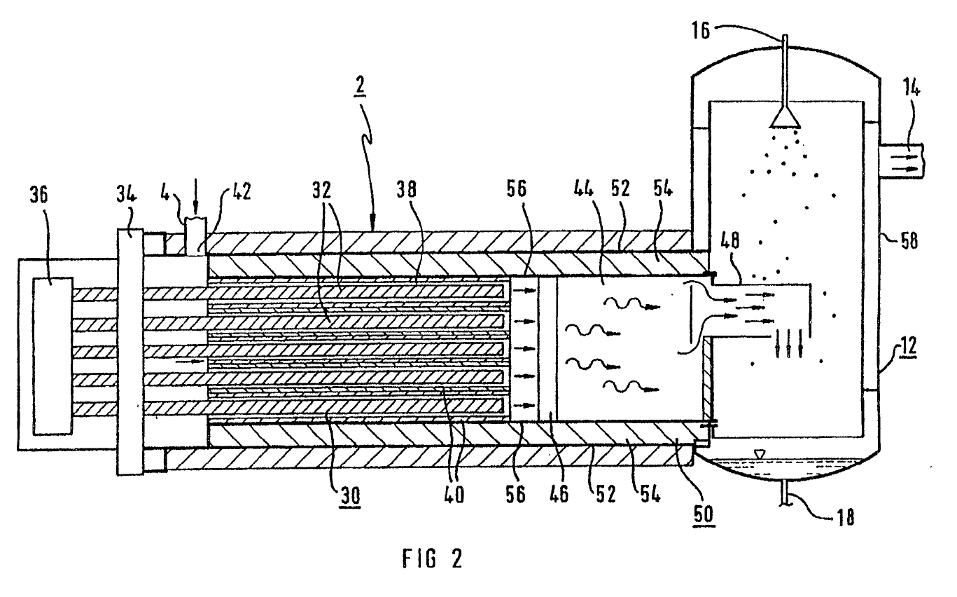

An embodiment of the recombinator unit 2 is presented in detail in FIG. 2. The recombinator unit according to FIG. 2 includes a heating chamber 30 which can be heated through the use of a number of heating elements 32. In the exemplary embodiment, twenty-four heating elements 32 are provided which are organized electrically as three groups. Each group includes eight heating elements 32 connected in series.

Alternatively, however, any other suitable number of heating elements 32 can be provided. The heating elements 32 are led through a common supporting plate 34, which also forms an interface of the heating chamber 30. The heating elements 32 are fastened in a common fixing device 36 at their ends protruding out of the heating chamber 30.

The heating chamber 30 includes a region 38, in which every heating element 32 is disposed inside its own flow pipe 40. Thus, within the region 38, every heating element 32, together with its respective flow pipe 40, forms an annular flow path for the gas mixture. The annular flow paths connect an inlet region 42 of the heating chamber 30 with a reaction chamber 44 connected to the heating chamber 30 on the downstream side. The inlet region 42 is connected to the feed line 4.

A static mixer 46, which is disposed in the reaction chamber 44, effects homogeneous mixing of partial streams of the gas mixture flowing out of the flow pipes 40. A deflecting device 48, which is connected on the outlet side of the reaction chamber 44, leads into an inner region of the spray or splash cooler 12.

The heating chamber 30, together with the reaction chamber 44 connected downstream thereof, are disposed inside an internally insulated housing 50. The housing includes a pressurized and thereby mechanically stressed outer casing 52. The outer casing 52 is lined with internal insulation 54 for the purpose of thermal insulation from the heating chamber 30 and the reaction chamber 44. A side of the internal insulation 54 facing the heating chamber 30 and the reaction chamber 44 is provided with an inner casing 56 acting as a heat shield. The materials for and the geometrical dimensioning of the internal insulation 54 and the inner casing 56 are selected in such a manner that even if the temperature in the inner region of the heating chamber 30 or the reaction chamber 44 exceeds, for example, 820° C., a temperature of no greater than approximately 450° C. is reached at the outer casing 52.

Thus, the outer casing 52 is thermally decoupled from the heating chamber 30 and the reaction chamber 44. As a result, even in a comparatively thin-walled construction, the outer casing 52 is also able to provide the level of pressure containment demanded by stringent safety requirements, through the choice of suitable, conventional materials.

The outer casing 52 is connected directly with a housing 58 of the spray or splash cooler 12 which is connected downstream of the reaction chamber 44, to form of a monolithic housing block. As a result, no pressure stressed pipeline is necessary for connecting the reaction chamber 44 with the downstream connected spray or splash cooler 12.

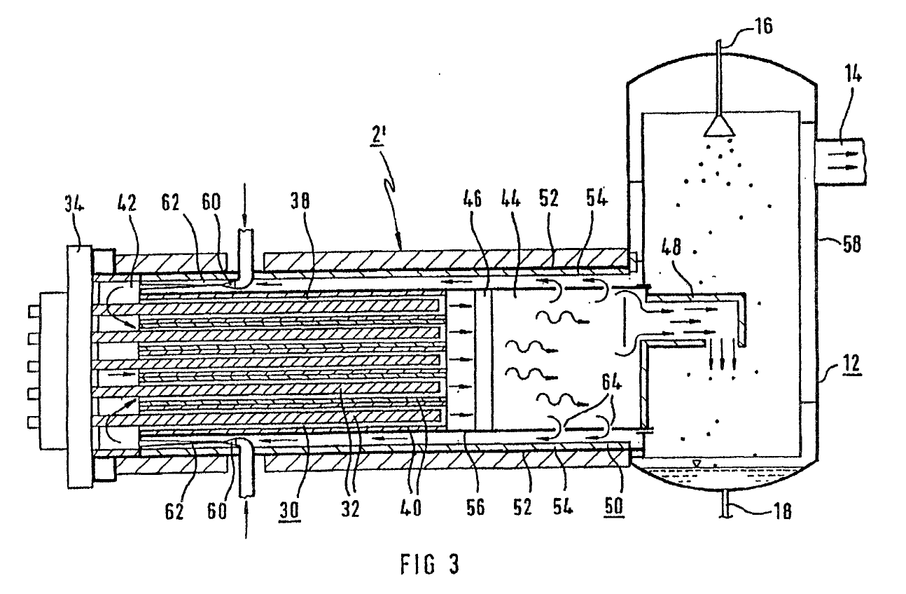

FIG. 3 shows an alternative construction of the recombinator unit 2′. In this case the recombinator unit 2′ is constructed equivalently to the recombinator unit 2 in essential aspects. However, in contrast thereto, it is constructed for nozzle-feeding of the gas mixture and for heating the static mixer 46 through the use of a partial stream of the gas mixture that is heated as a result of the recombination reaction.

In the recombinator unit 2′ according to FIG. 3 the feed line 4 leads into a number of nozzles 60 disposed around the heating chamber 30. The gas mixture leaving the nozzles 60 thereby enters a duct system 62 disposed between the inner casing 56 and the outer casing 52 in the inlet region 42 of the heating chamber 30.

A further difference from the recombinator unit 2 is that the inner casing 56 of the recombinator unit 2′ is provided in the region of the reaction chamber 44 with a number of transfer ports 64 which connect an inner space of the reaction chamber 44 with the duct system 62. As a result, while the recombinator unit 2′ is operating, a partial stream of the gas mixture reaching the reaction chamber 44 is able to flow into the duct system 62 and pass through it back to the inlet region 42 of the heating chamber 30. Insofar as feeding the gas mixture through the nozzles 60 into the inlet region 42 of the heating chamber 30 operates as a form of jet pump, a suction effect guarantees a minimum flow rate through the duct system 62. The partial stream flowing through the duct system 62 has an increased temperature as a result of the previous recombination reaction. This is used for heating the static mixer 46 disposed in the reaction chamber 44.

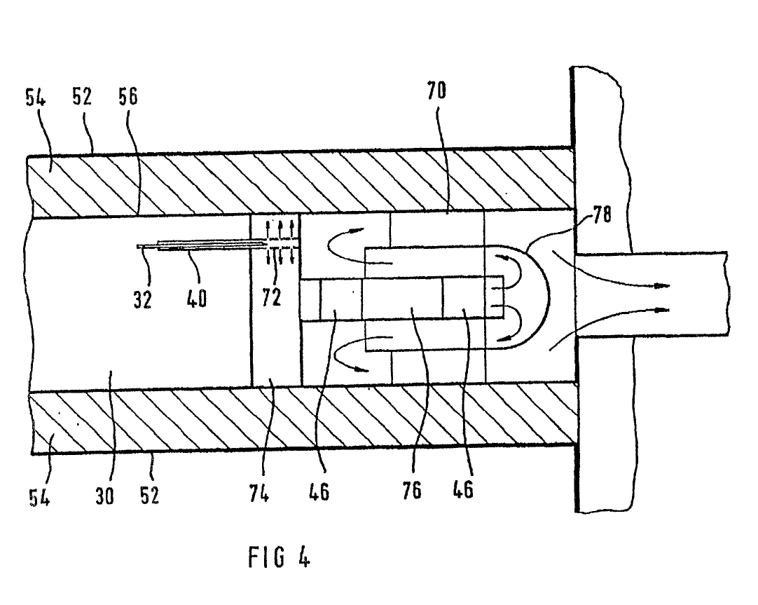

The recombinator unit 2, 2′ can also be equipped with an alternatively constructed reaction chamber 70, as represented in FIG. 4. In this embodiment the flow pipes 40, only one of which is shown in FIG. 4 together with the associated heating element 32, extend further in an axial direction than do the associated heating elements 32. In an end region 72, which is not occupied by the associated heating element 32, each flow pipe 40 is provided with drilled holes through which the gas mixture exits, in a direction perpendicular to the longitudinal axis of the respective heating element 32, into a common turbulence chamber 74. This leading together of the partial streams of the gas mixture carried by the flow pipes 40 in the common turbulence chamber 74 effects an especially intensive homogenization of all of the partial streams.

A swirl chamber 76, in which the static mixers 46 are disposed, is connected to a downstream side of the turbulence chamber 74. The swirl chamber 76 is thereby surrounded concentrically by a beaker-like flow element 78 in such a way that the gas mixture flowing out of the swirl chambers 76 is led along the outside of the swirl chamber in the opposite direction of flow. The gas mixture flowing out of the swirl chamber 76 has a temperature that is raised to approximately 800° C. as a result of the preceding recombination reaction. The gas mixture thus transfers at least part of its heat to the outer walls of the swirl chamber 76 and thereby also to the static mixer 46 disposed therein. In this way the static mixers 46 can also be heated in this embodiment through at least a partial stream of the gas mixture being heated as a result of the recombination reaction.

During operation of the device 1 a recombination of hydrogen and oxygen takes place in the gas mixture fed into the recombinator unit 2, 2′. In this process the gas mixture is first heated in the heating chamber 30. As a result of the thermal decoupling of the pressure-stressed outer casing 52 from the heating chamber 30, temperatures of greater than 800° C. can be used without cause for misgivings concerning safety. At such high temperatures the required recombination reaction takes place especially rapidly and efficiently so that high reaction yields can still be achieved even at the shorter dwell times resulting from higher gas flow rates.

The gas mixture flowing from the heating chamber 30 enters the reaction chamber 44 or the swirl chamber 76. There, the gas mixture is homogenized and completely reacted fractions of the gas mixture are mixed with possibly still unreacted components. This mixing process is further promoted through the static mixer or mixers 46. The heat content of the reacted fraction of the gas mixture is possibly strongly increased as a result of the exothermic recombination reaction and, as a result of this mixing process, part of this heat content is transferred to the still unreacted components of the gas mixture. These are heated as a result and the recombination reaction is thereby initiated. The device 1 is therefore characterized by an especially high efficiency for the recombination reaction.

However, the device 1 is also constructed for especially flexible operation, depending on the amount of hydrogen being generated. In order to enable especially variable operation in addition to electrical control of the heating elements 32, the device 1 is constructed for a demand-driven adjustment of the delivery rate or conveying capacity of the blower 6. For this purpose, a control unit 80 is provided for the drive motor 10 and thus also for the blower 6, as is illustrated in FIG. 1. The control unit 80 transmits an actuating signal to the drive motor 10, according to which the speed of the drive motor is adjusted and thereby also the delivery rate or conveyor capacity of the blower. An input side of the control unit 80 is connected with a hydrogen sensor 82 for determining the hydrogen content of the gas mixture.

The control unit 80 is constructed in such a way that the actuating signal for setting the speed of the motor is defined according to the hydrogen content determined in the gas mixture. Thus, during operation of the device 1, the delivery rate of the blower 6 is set according to the hydrogen content of the gas mixture and/or the reaction temperatures. Thus, for example upon start-up, the device 1 is adjusted to a minimum flow rate through the recombinator unit 2, 2′. The minimum flow rate may, for example, be 150 m³/h at maximum power output of the heating elements. If the hydrogen content of the gas mixture increases, the throughput is continuously increased in the form of an infinitely variable increasing flow rate, while maintaining the same heat output, and the increase in the hydrogen content is raised accordingly. Depending on demand, the throughput can be increased, for example, to up to 300 m³/h, i.e. a doubling of the throughput.

This kind of demand-controlled input to the recombinator unit 2, 2′ guarantees a reliable reduction in the amount of hydrogen in the gas mixture with especially high efficiency and with especially simple measures.

We claim:

1. A device for the recombination of hydrogen and oxygen in a gas mixture, comprising:
a heating chamber;
a feed line for feeding a gas mixture having a hydrogen content with a parameter characteristic, into said heating chamber;
a blower connected in said feed line and having a delivery rate; and
a control unit associated with said blower for adjusting the delivery rate of said blower in dependence on the parameter characteristic for the hydrogen content of the gas mixture.

2. The device according to claim 1, including a hydrogen sensor for determining the hydrogen content of the gas mixture, said control unit having an input side connected to said hydrogen sensor.

3. The device according to claim 1, including a number of heating elements for heating said heating chamber.

4. The device according to claim 3, including flow pipes, each of said heating elements disposed within a respective one of said flow pipes.

5. The device according to claim 1, wherein said heating chamber has a downstream side, and a reaction chamber is connected at said downstream side of said heating chamber.

6. The device according to claim 1, including a static mixer connected downstream of said heating chamber.

7. The device according to claim 6, wherein the gas mixture has a flow path permitting said static mixer to be heated by a partial stream of the gas mixture heated as a result of a recombination reaction.

8. The device according to claim 1, including an internally insulated housing in which said heating chamber is disposed.

9. The device according to claim 8, wherein said heating chamber has a downstream side, a splash cooler is connected on said downstream side of said heating chamber, and said splash cooler has a housing directly connected to said internally insulated housing in which said heating chamber is disposed.

10. The device according to claim 1, wherein the parameter characteristic is a measured temperature value of the gas mixture flowing out of said heating chamber.

11. A method for the recombination of hydrogen and oxygen in a gas mixture, which comprises:
feeding a gas mixture through a feed line having a blower into a heating chamber; and
adjusting a delivery rate of the blower in dependence on a parameter characteristic for a hydrogen content of the gas mixture.

12. The method according to claim 11, wherein the parameter characteristic is a direct measured value of the hydrogen content.

13. The method according to claim 11, wherein the parameter characteristic is a measured temperature value of the gas mixture flowing out of the heating chamber.
